(19) United States
(12) Patent Application Publication
(10) Pub. No.: US 2004/0237397 A1
(43) Pub. Date: Dec. 2, 2004

(54) Hydroponic planter box

(76) Inventor: Robert Zintz, Teaneck, NJ (US)

Correspondence Address: Robert D. Katz, Esq., COOPER & DUNHAM LLP, 1185 Avenue of the Americas, New York, NY, 10036, US

(21) Appl. No.: 10/439,475

(22) Filed: May 16, 2003

(51) Int. Cl. A01G 9/02

(52) U.S. Cl. 47/66.6

(57) ABSTRACT

The invention provides a hydroponic planter which doubles as a cover for a common toilet tank. The planter includes reservoir for holding plants supported in a hydroponic growth medium. The reservoir has several openings through which wicks extend to bring water from the toilet tank to the interior of the reservoir. The openings are arranged so that the wicks do not interfere with the flush mechanism of the toilet tank.

### FIELD OF THE INVENTION

This invention relates to planters useful as lavatory tank covers, and more particularly to hydroponic planters that serve as covers for toilet tanks.

### BACKGROUND OF THE INVENTION

Plants are often used to decorate various parts of a home or office, including the bathroom or washroom. Toward that end, there have been designs put forth for planters that serve as covers for the flush tank of a conventional toilet or commode. For example, U.S. Pat. No. 4,174,589 (Daharsh) illustrates a bathroom planter box for bathrooms using a specially adapted planter structure that sits atop the flush tank of a toilet, in place of the cover therefor. The planter includes drainage ports in the lower portion of the planter to allow fluid to flow into the commode tank. The drainage ports have a mesh screen and a replaceable filter to prevent soil from escaping into the tank. A small hand pump helps to siphon water from the tank to use to water the plants contained in the box.

U.S. Pat. No. 6,408,450 (Giaimis) features a decorative vase and toilet tank cover. The toilet tank cover has a raised aperture and a perforated basket attached underneath the raised aperture. The perforated basket and raised aperture form a decorative vase, which can be easily broken down for removal and cleaning. According to the patentee, the perforated basket is made of flexible thermoplastic material that is attached to the ceramic toilet tank cover by a pair of inverted ceramic buttons and slots. The holes in the perforated basket are designed to hold a set of flowers while allowing water to enter through the exterior of the perforated basket.

The foregoing devices seek to provide planters for use in the bathroom, but seem to require a fair amount of attention in order for the plants to thrive. It would therefore be desirable to provide a bathroom planter that makes use of hydroponic technology to help plants stay healthy without significant amounts of attention.

### SUMMARY OF THE INVENTION

The foregoing and other disadvantages are overcome, and the objects of the invention are achieved by providing a hydroponic planter to cover a toilet tank in accordance with the present invention. The planter comprises a watertight container or reservoir sized to fit on a toilet tank. The container has an open top, vertical sidewalls and a bottom wall to define an interior volume for holding one or more plants and accompanying hydroponic growth medium. The container includes a plurality of orifices spaced in the bottom wall of the container for allowing passage of water into and out of the container. A series of wicks extend through the orifices in the bottom wall to provide fluid communication between the interior volume and water in the reservoir tank of the toilet. The container or reservoir contains hydroponic aggregate or planting material, such as perlite, vermiculite, or the like, into which one or more plants may be positioned. The wicks are preferably located to avoid interfering with the flush mechanism included in the reservoir tank. The wicks draw water from the tank into the interior volume or reservoir to provide moisture to the plants embedded in the hydroponic aggregate, and to allow drainage of excess moisture from the aggregate into the tank. In this way, the plants receive needed water without frequent intervention from a home owner.

### BRIEF DESCRIPTION OF THE DRAWINGS

Other objects and advantages of the invention will become apparent upon reading the following detailed description of the preferred embodiments taken in conjunction with the drawings, in which:

FIG. 1 is a perspective view of a hydroponic planter toilet tank cover seated on a toilet tank in accordance with the present invention; and

FIG. 2 is a diagrammatic, isometric view of the hydroponic planter of the present invention, shown without plants or planting material.

### DETAILED DESCRIPTION OF THE PREFERRED EMBODIMENTS

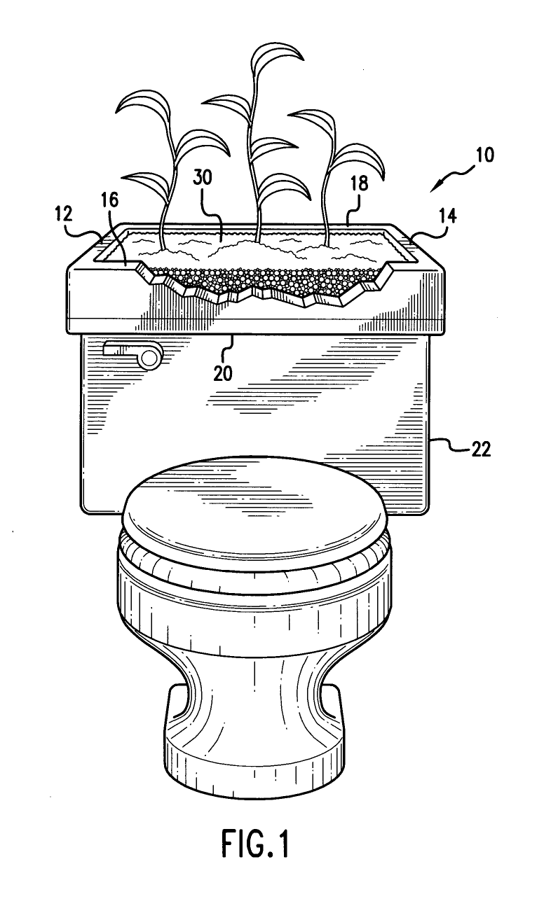

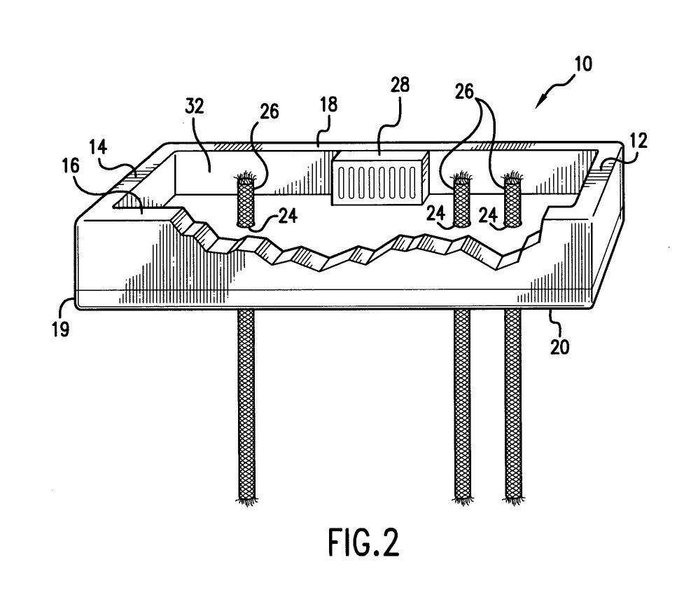

Referring to the drawings, FIG. 1 illustrates the hydroponic planter of the present invention, generally designated by the reference numeral 10. The planter 10 includes a pair of opposed, spaced apart, generally parallel upright side walls 12, 14, a pair of generally parallel, spaced apart upright front and rear walls 16, 18, and a horizontal bottom wall 20. The five walls together define an open top, watertight container with a reservoir to hold the plant growth medium and plants. The walls are sized to fit a standard commode tank 22, and to serve as a replacement for the tank cover (not shown) supplied with the commode. The planter may also include a rim or lip 19 to help seat the planter 10 on the tank 22, as shown in FIG. 2. The walls may be made of a durable plastic material, such as Plexiglas, or Lucite, if a transparent planter is desired. Otherwise, other plastic, glass, or ceramic materials may be used as desired to give the planter 10 a chosen appearance, and a desired color.

As shown in FIG. 2, the bottom wall 20 has at least one, and preferably several, openings 24 therein for wicks 26 to extend from the interior of the planter 10 to the exterior. The wicks 26 are preferably cotton or nylon rope, about one half inch in diameter, and extend up to about one foot in length, so that when the planter 10 is positioned on top of a toilet tank 22, the wicks 26 will reach below the water level (not shown) in the tank 22. The wicks 26 are preferably chosen to have sufficient diameter to fill or mostly fill the openings 24 in the bottom wall 20 of the planter 10, and are frayed at each end to help with absorption and dispersion of water. The planter 10 also includes a perforated or slotted plant food dispenser 28, preferably adjacent the rear wall 18, so as to be hidden from view. The food dispenser 28 contains and dispenses plant nutrients, from a slow release plant food tablet, granules, or briquette, such as Miracle Gro Slow Release Plant Food, available from the Scotts Company of Marysville, Ohio.

The growth medium 30 can be any growing medium conventionally used for hydroponic planters, such as sand, gravel, perlite, vermiculite or a combination thereof. Such materials are available from hydroponic plant supply stores or garden or nursery supply shops.

To set up and use the planter 10 of the present invention, the wicks 26 are inserted in the openings 24 in the planter 10, and may be knotted or otherwise secured or arranged to prevent them from slipping through the openings 24 into the tank 22. The planter 10 is placed on the tank 22 so that it covers the opening therein, and so that the wicks 26 extend into the tank 22 beneath the water line. Growth medium 30, preferably perlite, vermiculite, or the like, is added to the planter 10 in sufficient quantity to fill or mostly fill the reservoir 32 in the planter 10. Plants 34 are inserted in the growth medium 30 so that the roots are covered and that each of the plants is supported, and remains upright. A variety of plants can be used, selected for viability in hydroponic growth, with consideration given to the amount and type of light available for the location of the planter. If desired, or advisable for the type of plant used, a plant food supplement should be added to the dispenser, and replaced as needed.

The invention thus provides a convenient, attractive planter that will enhance bathroom decor and provide a source of oxygen to the environment, while requiring little attention or care from the owner. It can sustain a variety of plants, and not require attention, which busy homeowners may find undesirable.

While the invention has been described in conjunction with specific embodiments thereof, it should be understood that many modifications, variations and equivalents will be apparent to those skilled in the art, upon reviewing this specification. Accordingly, it is intended that all such modifications, variations, and equivalents be covered by the following claims.

1. A hydroponic planter for a toilet tank, comprising:
a watertight reservoir sized to fit on a toilet tank, having an open top, sidewalls and a bottom wall to define an interior space for holding one or more plants and a hydroponic growth medium, the bottom wall having a plurality of orifices included therein for allowing passage of water into and out of the interior space;
hydroponic aggregate or planting material into which one or more plants may be positioned; and
a series of wicks extending through the orifices to draw water from the toilet tank into the interior volume of the planter to provide moisture to the plants embedded in the hydroponic aggregate, and to allow drainage of excess moisture from the interior volume into the toilet tank, wherein the orifices are located in the bottom wall to avoid interfering with the flush mechanism included in the toilet tank.

2. (canceled)

3. (canceled)

4. A hydroponic planter for a toilet tank in accordance with claim 1, wherein the planter additionally comprises a dispenser for plant food or fertilizer, the dispenser located adjacent the rear wall of the planter.

5. A hydroponic planter for a toilet tank comprising:
a watertight reservoir sized to fit on a toilet tank, having an open top, sidewalls and a bottom wall to define an interior space for holding one or more plants and a hydroponic growth medium, the bottom wall having a plurality of orifices included therein for allowing passage of water into and out of the interior space;
a series of wicks extending through the orifices to provide fluid communication between the interior space and water in the toilet tank, wherein the orifices are located in the bottom wall to avoid the wicks from interfering with the flush mechanism included in the toilet tank;
a hydroponic aggregate or planting material into which one or more plants may be positioned; and
a dispenser for plant food or fertilizer, the dispenser located adjacent the rear wall of the planter.

6. A hydroponic planter for a toilet tank in accordance with claim 1, wherein the hydroponic aggregate or planting material is perlite or vermiculite.

7. A hydroponic planter for a toilet tank in accordance with claim 5, wherein the hydroponic aggregate or planting material is perlite or vermiculite.
